(19) United States
(12) Patent Application Publication
(10) Pub. No.: US 2013/0046560 A1
(43) Pub. Date: Feb. 21, 2013

(54) SYSTEM AND METHOD FOR DETERMINISTIC AND PROBABILISTIC MATCH WITH DELAYED CONFIRMATION

(71) Applicants: Garry Jean Theus, Manchester, CT (US); James L. Pabilonia, Tolland, CT (US); Jennifer B. Raibeck, South Windsor, CT (US); Shawn K. Simpson, Manchester, CT (US); Nancy J. Sullivan, Vernon, CT (US)

(72) Inventors: Garry Jean Theus, Manchester, CT (US); James L. Pabilonia, Tolland, CT (US); Jennifer B. Raibeck, South Windsor, CT (US); Shawn K. Simpson, Manchester, CT (US); Nancy J. Sullivan, Vernon, CT (US)

(21) Appl. No.: 13/213,513

(22) Filed: Aug. 19, 2011

(51) Int. Cl. G06Q 40/00; G06F 17/30

(52) U.S. Cl. 705/4; 707/780; 707/E17.014

(57) ABSTRACT

Some embodiments may be directed to matching users, such as employees, with insurance records in an integrated database, wherein the integrated database includes a plurality of insurance records, each record being associated with a unique employee and having a plurality of fields. According to some embodiments, new employee information may be received and it may be determined that the new employee information does not qualify as a strong match with any insurance record in the integrated database. Moreover, it may be determined, based on a probabilistic pattern match of the new employee information with values in the fields of the integrated database, that the new employee information qualifies as a weak match with a particular insurance record in the integrated database. Subsequent to the determination of a weak match, supplemental employee information may be received, and, responsive to the supplemental employee information, the match between the new employee information and the particular insurance record in the integrated database may be upgraded from a weak match to a strong match.

### BACKGROUND

In some cases, it may be desirable to match information associated with a user with a particular record in a database, such as an integrated database that contains multiple records, each record associated with a different user. For example, an insurance claims processing system might maintain an insurance claim database containing millions of records. When new information is received, it may be necessary to match that new information with a particular record in the integrated database (e.g., to facilitate processing of an insurance claim associated with a particular user). Typically, user identifiers (e.g., associated with his or her Social Security Number, name, or date of birth) may be used to match the new information with a record in the database.

For a number of reasons, the values of user identifiers might not perfectly match the values stored in the integrated database. As one example, the integrated database may contain values that were input via a number of different input methods (e.g., by importing values from different source databases, having an operator enter information received via a telephone call from a user, or a printed form that was filled out by a user). Moreover, the values may change over time (e.g., a user might become married or move to a new postal address), typographical errors might exist, and/or there might be multiple ways to represent the same information (e.g., “st.” or “street” and “Joe” or “Joseph”).

As a result, it can be difficult to match new user information with an appropriate record in order to facilitate the processing of an insurance claim. It would therefore be desirable to provide systems and methods for automatically and accurately matching new user information with a particular record in an integrated database.

### SUMMARY OF THE INVENTION

According to some embodiments, systems, methods, apparatus, computer program code and means for automatically and accurately matching new user or employee information with a particular group benefits based insurance record in an integrated database are disclosed. Some embodiments may be directed to matching employees with records in an integrated database, wherein the integrated database includes a plurality of group benefits based insurance records, each group benefits based insurance record being associated with a unique employee and having a plurality of fields. According to some embodiments, new employee information may be received and it may be determined that the new employee information does not qualify as a strong match with any group benefits based insurance record in the integrated database. Moreover, it may be determined, based on a probabilistic pattern match of the new employee information with values in the fields of the integrated database, that the new employee information qualifies as a weak match with a particular group benefits based insurance record in the integrated database. Subsequent to the determination of a weak match, supplemental employee information may be received, and, responsive to the supplemental employee information, the match between the new employee information and the particular group benefits based insurance record in the integrated database may be upgraded from a weak match to a strong match.

A technical effect of some embodiments of the invention is an improved and computerized method to match new user or employee information with a group benefits based insurance particular record in an integrated database. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is block diagram of a system according to some embodiments of the present invention.

FIG. 4 illustrates a dataflow in accordance with some embodiments of the present invention.

FIG. 5 is an example of probabilistic pattern matching in accordance with some embodiments described herein.

FIG. 6 illustrates database record matching when new user information is received according to some embodiments of the present invention.

FIG. 7 illustrates a strong match when new user information is received according to some embodiments of the present invention.

FIG. 8 illustrates a weak match when new user information is received according to some embodiments of the present invention.

FIG. 9 illustrates updating a weak match to a strong match when supplemental user information is received according to some embodiments of the present invention.

FIG. 10 illustrates updating a weak match to a strong match when supplemental user information is received from a user according to some embodiments of the present invention.

FIG. 11 illustrates how a weak match might be quarantined when new user information is received according to some embodiments of the present invention.

FIG. 12 is a block diagram of an integrated database access platform in accordance with some embodiments of the present invention.

### DETAILED DESCRIPTION

In some cases, it may be desirable to match information associated with a user with a particular record in a database, such as an integrated database that contains multiple records, each record associated with a different user. For example, an insurance claims processing system might maintain an insurance claim database containing millions of records. When new information is received, it may be necessary to match that new information with a particular record in the integrated database (e.g., to facilitate processing of an insurance claim associated with a particular user). Typically, user identifiers (e.g., associated with his or her Social Security Number, name, or date of birth) may be used to match the new information with a record in the database.

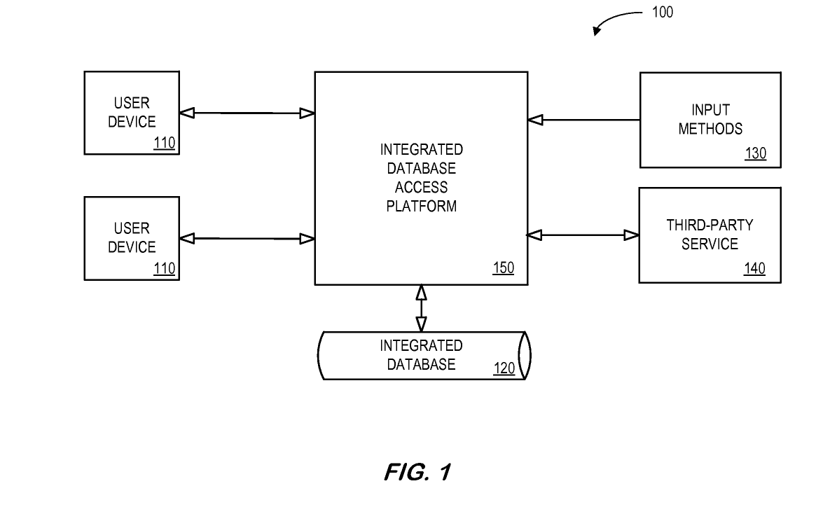

FIG. 1 is block diagram of a system 100 according to some embodiments of the present invention. In this example, an integrated database access platform 150 may communicate with a number of remote user devices 110 via a communication network. The user devices 110 may represent wireless telephones, Personal Computers (PCs), laptop computers, automobile devices, or any other apparatus able to exchange information with the integrated database access platform 150. By way of example only, the user devices 110 may be associated with an iPhone® from Apple, Inc., a BlackBerry® from RIM, a mobile phone using the Google Android® operating system, a portable or tablet computer (such as the iPad® from Apple, Inc.), a mobile device operating the Android® operating system or other portable computing device having an ability to communicate wirelessly with a remote entity such as the integrated database access platform 150. The user may use the user device 110, for example, to submit a new insurance claim, check on the status of an insurance claim being processed, etc.

According to some embodiments, the user device 110 transmits new user information to the integrated database access platform 150. The new user information might include, for example, his or her name, Social Security number, date of birth, username and password, etc. The integrated database access platform 150 may then attempt to match the new user information with a particular record stored in an integrated database 120.

According to some embodiments, the integrated database access platform 150 may be “automated” in that embodiments described herein may be performed with little or no human intervention. By way of example only, the integrated database access platform 150 may be associated and/or communicate with a PC, an enterprise server, a database farm, and/or a consumer device. The integrated database access platform 150 may, according to some embodiments, be associated with an insurance processing system associated with various types of insurance policies, including group benefits based such as life and disability, health, automobile, and home insurance policies, for individuals and/or companies.

As used herein, devices including those associated with the integrated database access platform 150, and any other device described herein may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Although a single integrated database access platform 150 is shown in FIG. 1, any number of such devices may be included. Moreover, various devices described herein might be combined according to embodiments of the present invention. For example, in some embodiments, the integrated database access platform 150 and integrated database 120 might be co-located and/or may comprise a single apparatus.

The integrated database access platform 150 may receive new user information from a user device 110 (e.g., when a user accesses an insurance web page) and attempt to match that new user information with a record stored in the integrated database 120. For a number of reasons, the values of user identifiers received from a user device 110 might not perfectly match the values stored in the integrated database 120. As one example, the integrated database may contain values that were input via a number of different input methods 130 (e.g., by importing values from different source databases, having an operator enter information received via a telephone call from a user, or a printed form that was filled out by a user). Moreover, the values may change over time (e.g., a user might become married or move to a new postal address), typographical errors might exist, and/or there might be multiple ways to represent the same information (e.g., “st.” or “street” and “Joe” or “Joseph”).

As a result, it can be difficult to match new user information with an appropriate record in order to facilitate the processing of an insurance claim. It would therefore be desirable to provide systems and methods for automatically and accurately matching new user information with a particular record in an integrated database. As will be described herein, the integrated database access platform 150 may, in some embodiments, receive supplemental information from a user device 110 and/or a third party service 140 (e.g., information that is received subsequent to and/or delayed with respect to the receipt of the original new user information) to facilitate such matching.

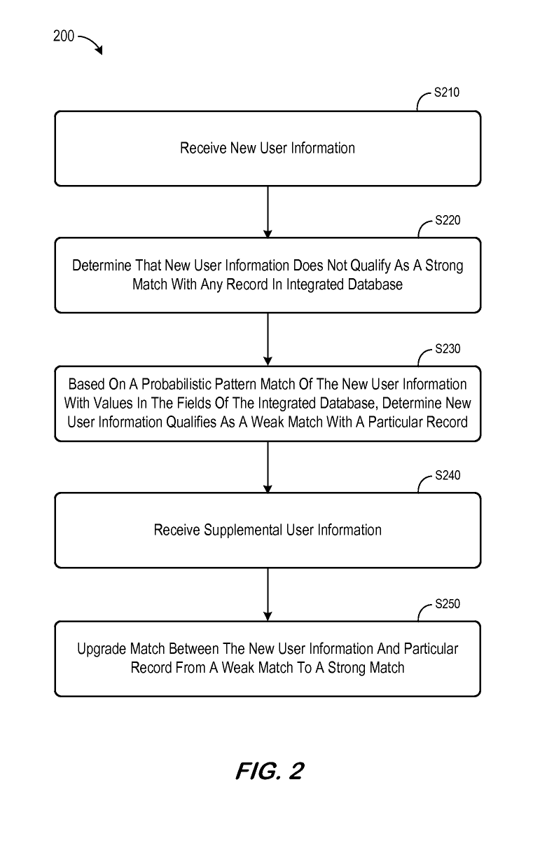

FIG. 2 illustrates a method 200 that might be performed, for example, by some or all of the elements of the system 100 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein. The method 200 may facilitate a matching of users or employees with records (e.g., health insurance records) in an integrated database, wherein the integrated database includes a plurality of records, and each record is associated with a unique user and has a plurality of fields. The information in the integrated database may have been created, for example, by integrating user data input via a plurality of independent methods and/or a data cleansing process (e.g., a process that removes extra spaces and/or converts “St.” to “STREET”). According to some embodiments, the integrated database is associated with employees, insurance policies, insurance claims, and/or leave management.

At S210, new user information may be received. The new user information might be, for example, information about an employee that is received from a remote user device via a communication network. According to some embodiments, the new user information includes name information (e.g., a first and last name), a Social Security number, gender information, a date of birth, a ZIP code, an employee identifier, an employer identifier, an integrated database identifier, an address, and/or a telephone number.

At S220, it may be determined that the new user information does not qualify as a “strong” match with any record in the integrated database. For example, in some cases all of the following information might exactly match a health related insurance record stored in the integrated database: (1) the user's first and last name, (2) the user's Social Security number, and (3) the user's date of birth. In this situation, it may be relatively easy task to determine which record in the integrated database is associated with the new user information. In other cases, however, the information will not match exactly and thus no “strong” link may be established.

At S230, it may be determined, based on a probabilistic pattern match of the new user information with values in the fields of the integrated database, that the new user information qualifies as a “weak” match with a particular record in the integrated database. For example, the probabilistic pattern matching may be associated with a closeness rule and a confidence level compared to a predetermined threshold. According to some embodiments, the probabilistic pattern matching assigns a matching score or grade to each field in the integrated database. Moreover, according to some embodiments information may be placed in quarantine when there is a conflict with key user information such as SSN, employee id. For example, for registered users, a mismatch DOB could also force a record to go to quarantine.

Subsequent to said determination of a weak match at S230, supplemental user information may be received at S240. According to some embodiments, the supplemental user information is received from a remote user device via the communication network (e.g., he or she may be asked to provide additional information via a Web interface). According to other embodiments, the supplemental user information is received from a third-party service (e.g., a credit rating agency or department of motor vehicles).

Responsive to said supplemental user information, the match between the new user information and the particular record in the integrated database may be upgraded at S250 from a weak match to a strong match. As a result, the appropriate record in the integrated database may have been located and the transaction being initiated for the new user may be processed (e.g., in connection with his or her insurance claim).

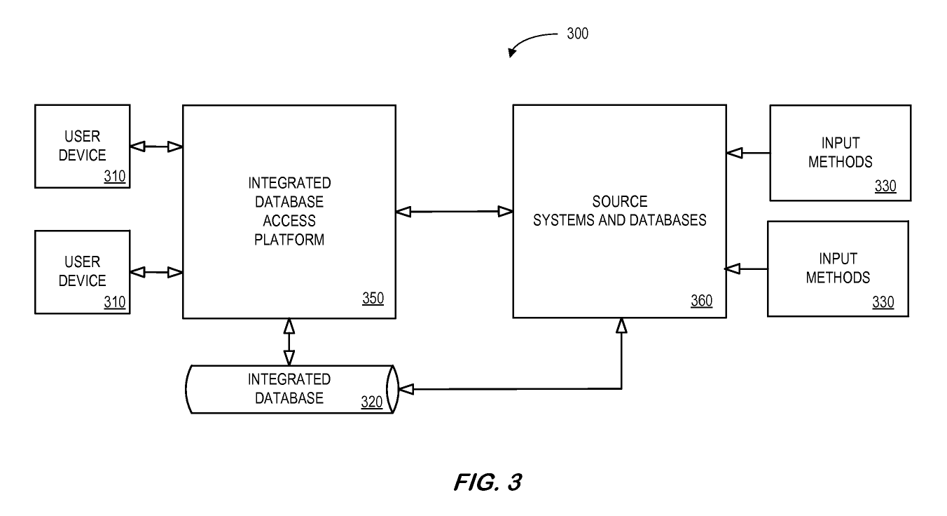

FIG. 3 is block diagram of a system 300 according to some embodiments of the present invention. As before, an integrated database access platform 350 may communicate with a number of remote user devices 310 via a communication network. According to some embodiments, the user device 310 transmits new user information to the integrated database access platform 350. The new user information might include, for example, his or her name, Social Security number, employee identifier, date of birth, ZIP code, telephone number, etc. The integrated database access platform 350 may then perform a vetting process to match the new user information with a particular record stored in an integrated database 320.

For a number of reasons, the values of user identifiers received from a user device 310 might not perfectly match the values stored in the integrated database 320. As one example, the integrated database may contain values that were input via a number of different input methods 330 and/or processed via a number of different source systems and databases 360. By way of examples only, the independent input methods 330 may comprise imports from other databases (e.g., maintained by an employer, an underwriting entity, or group benefit provider), information provided by a consumer (e.g., via a web portal or email), information received from telephone call centers, etc. According to some embodiments, a “case identifier” or “party identifier” may be utilized to help match records from multiple source systems and databases 360.

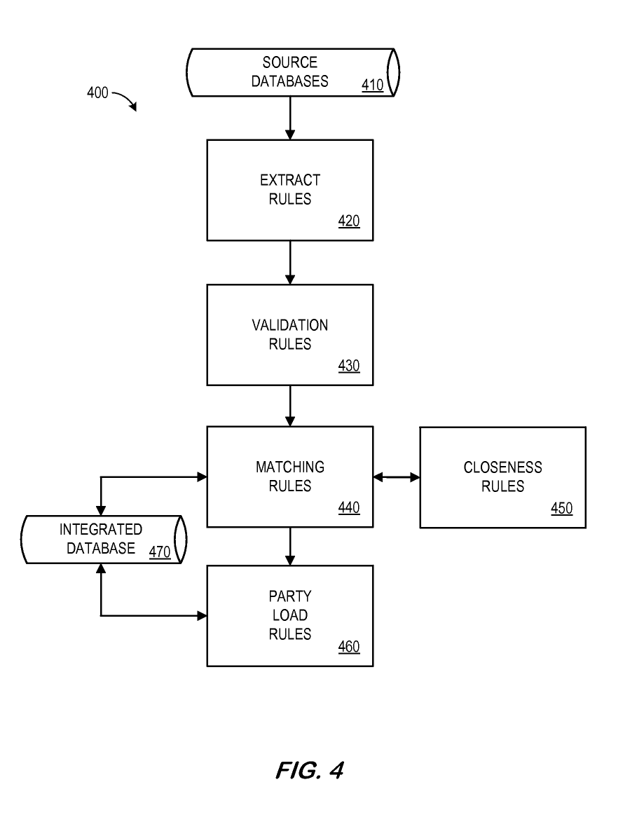

FIG. 4 illustrates a dataflow 400 that might be associated with the integrated database access platform 350 in accordance with some embodiments of the present invention. Initially, extract rules 420 may be executed on information in one or more source databases 410. The extract rules 420 may, for example, filter for extracting source system consumer party records from various source systems (e.g., associated with insurance claims or eligibility databases).

Next, validation rules 430, such as party attribute validation rules may be executed. The validation rules 430 may, for example, ensure that incoming consumer party attributes contain valid values (e.g., having an appropriate length and/or alphanumeric characteristics).

Moreover, one or more matching rules 440 may be applied to the data. The matching rules 440 may, for example, match incoming source system consumer party records with existing integrated database records. The matching might be based on, for example, a source identifier (e.g., indicate where the data came from), a Social Security number, an employee identifier, a date of birth, a name (e.g., first and last name), a ZIP code, and/or a gender. The matching rules 440 may result in, for example, a determination that no match can be found, that a “strong” match was found, that a “weak” match was found, and/or an indication that information would be quarantined. The matching rules 440 may, according to some embodiments, be based at least in part on information in an integrated database 470 (e.g., storing candidate source system consumer party records) and one or more closeness rules 450 (e.g., to assign a confidence level between the incoming consumer party source system record and candidates retrieved from the integrated database 470). According to some embodiments, a consumer may be prevented from access information when a match is currently defined as “weak.” That is, additional information from the user, or from a third party service, or an update from a source system may be required to upgrade the match to “strong” before the user may view and/or change information in the integrated database 470.

By way of example, a matching rule 440 might initially lookup a source identifier to determine whether an incoming record already exists (and, if so, a strong match might be determined). A matching rule 440 might also look for an exact match of all of the following: Social Security number, date of birth, and name (and, if so, a strong match might be determined).

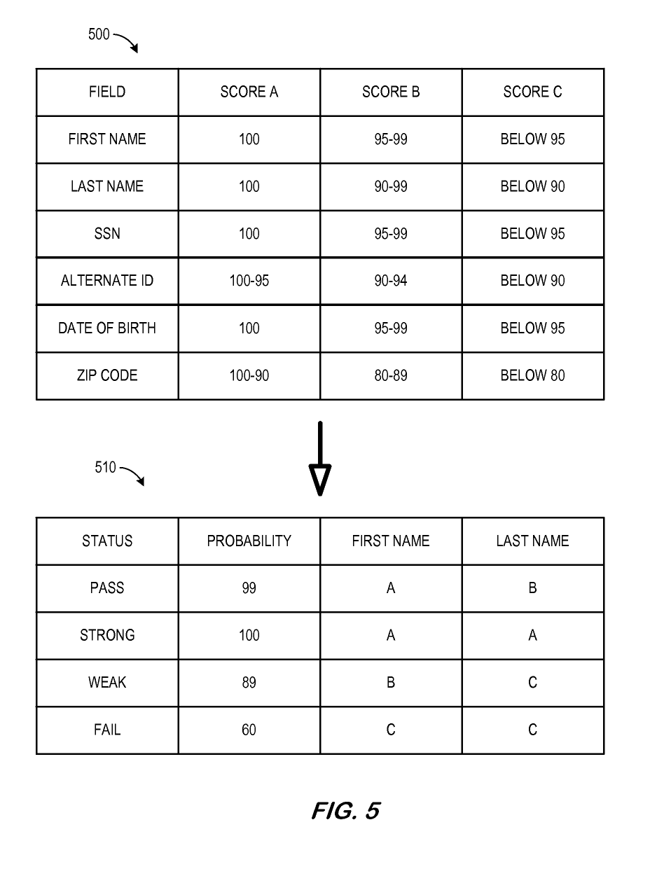

Other matching rules 440 might result in a weak match determination or a probabilistic match wherein a likelihood of a true match may be established (knowing that a possibility of a false positive match exists). For example, the closeness rule 450 may generate a value that may be compared to a pre-determined confidence level threshold value. Consider, for example, FIG. 5 which is an example of probabilistic pattern matching in accordance with some embodiments described herein. In this case, a scoring table 500 may define various scores or grades (e.g., “A,” “B,” or “C”) for various fields in a record (e.g., a name or Social Security number). In the example of FIG. 5, the field “Data of Birth” receives a score of “A” if there is a 100% level of confidence, a score of “B” if the confidence level is between 95% and 99%, and a score of “C” otherwise. Note that the scoring table 500 might include multiple identifiers that may be associated with a single party. For example, both a Social Security number and Alternate ID (e.g., an employee badge number) might be associated with a single employee. According to some embodiments different identifiers may be associated with different scores, levels of trust, and/or link strength (e.g., may result in a weak link, a strong link, etc.).

Moreover, a pattern definition table 510 may assign probabilities of an overall record match based on various score combinations for various records. For example, an overall record probability of 89% may be determined when the first name receives a score of “B” and the last name receives a score of “C.” Note that the values and fields illustrated herein are only provided as examples and many more records and/or scores may be employed in accordance with any of the embodiments described herein. Further note that various overall record probabilities in the table 510 may be mapped to various statuses (e.g., strong or weak matches).

Referring again to FIG. 4, one or more party load rules 460 may then ensure that a source system consumer party record association with a particular record in the integrated database 470 is valid. This may, according to some embodiments, result in a quarantined record (e.g., when two consumer party source system records have the same Social Security number or employee identifier).

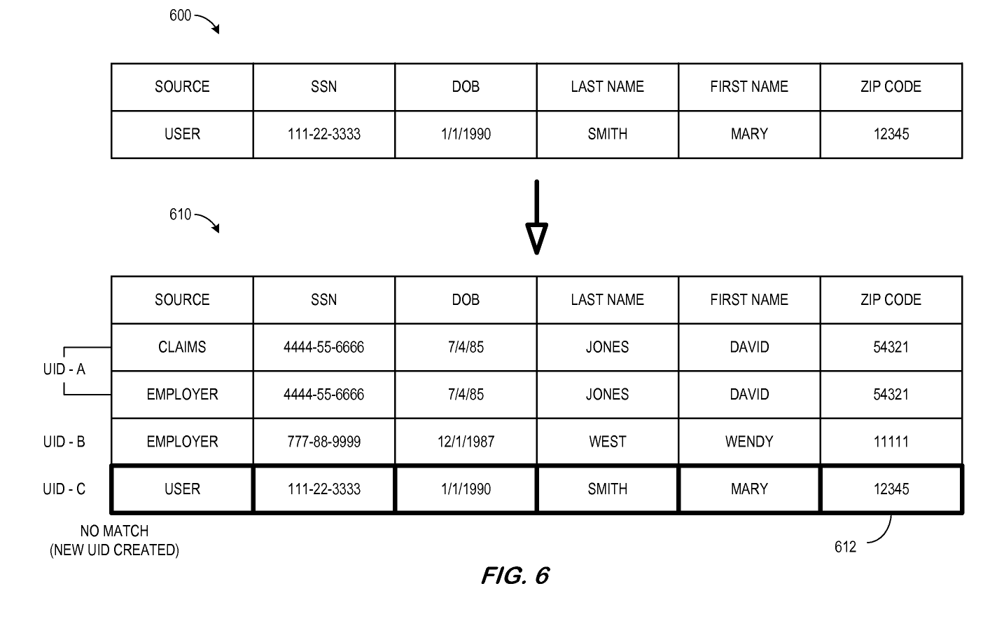

FIG. 6 illustrates database record matching when new user information is received according to some embodiments of the present invention. In this example, new user information 600 is received and compared to information in an integrated database 610. The new user information 600 is received from a user (the source), such as via a web page, and includes the user's Social Security number, date of birth, last name, first name, and ZIP code. Note that the integrated database 610 might initially include three records, two associated with User Identifier (UID) “A” and one associated with UID B. Based on matching and/or closeness rules, it is determined that the new user information 600 does not remotely match any of the records in the integrated database. As a result, a new record 612 is added to the integrated database 610 for a new UID “C.”

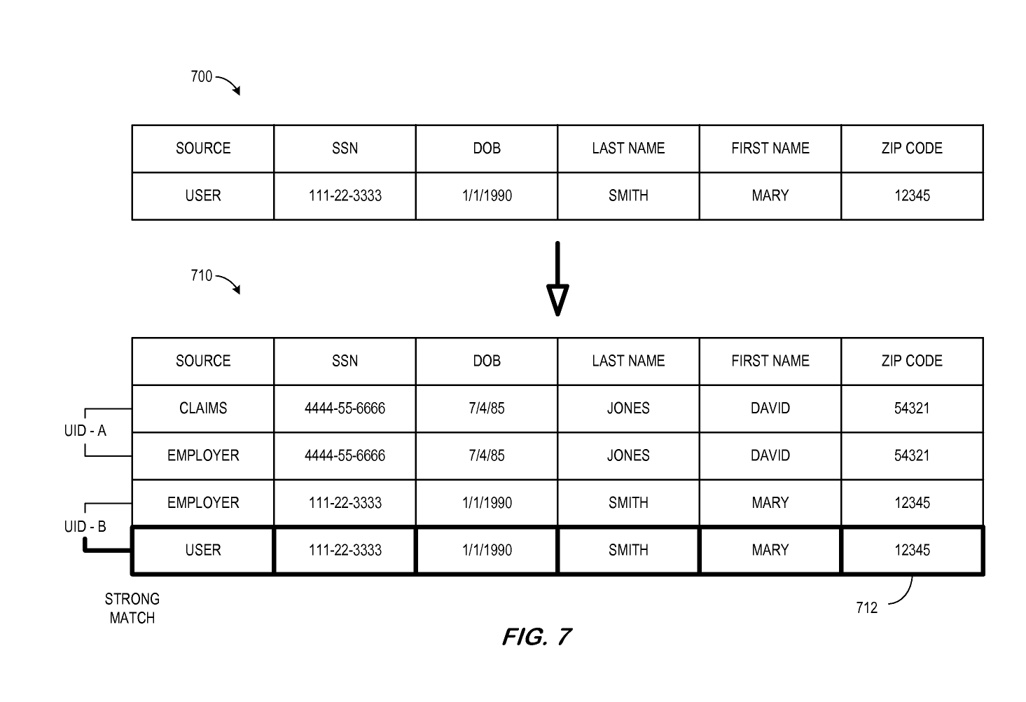

FIG. 7 illustrates a strong match when new user information is received according to some embodiments of the present invention. As before, new user information 700 is received and compared to information in an integrated database 710. The new user information 700 is received from a user (the source), such as via a web page, and includes the user's Social Security number, date of birth, last name (“Smith”), first name (“Mary”), and ZIP code. Note that the integrated database 710 might initially include three records, two associated with UID A and one associated with UID B. In this example, an exact and perfect match between the new user information 700 and a record in the integrated database 710 is found (that is, all of the information for Mary Smith matches with the values stored for UID B). As a result, a new record 712 is added to the integrated database 710 and is strongly linked to UID B (illustrated by a solid bold line in FIG. 7). Mary Smith may then be allowed to access and/or update her information in the integrated database 710.

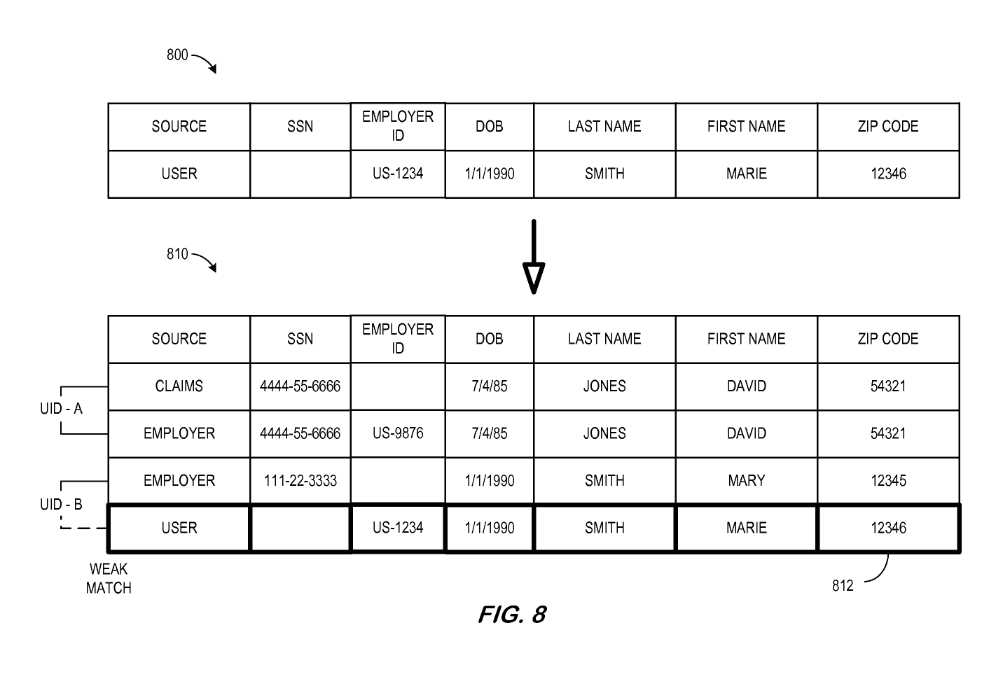

FIG. 8 illustrates a weak match when new user information is received according to some embodiments of the present invention. Once again, new user information 800 is received and compared to information in an integrated database 810. The new user information 800 is received from a user (the source), such as via a web page, and includes the user's employer identifier, date of birth, last name (“Smith”), first name (“Marie”), and ZIP code. Note that the integrated database 810 might initially include three records, two associated with UID A and one associated with UID B. In this example, probabilistic match between the new user information 800 and a record in the integrated database 810 is found (that is, much of the information for Marie Smith matches with the values stored for UID B). In particular, “Marie” does not exactly match “Mary” and the ZIP code “12346” does not exactly match “12345.” Moreover, the level of confidence placed in an employer identifier might be less than, for example, a level of confidence associated with a Social Security number. The probabilistic match might be performed, for example, as described with respect to FIG. 5. As a result, a new record 812 is added to the integrated database 810 and is weakly linked to UID B (illustrated by a dashed line in FIG. 8). In this case, Marie Smith may not yet be allowed to access and/or update her information in the integrated database 810.

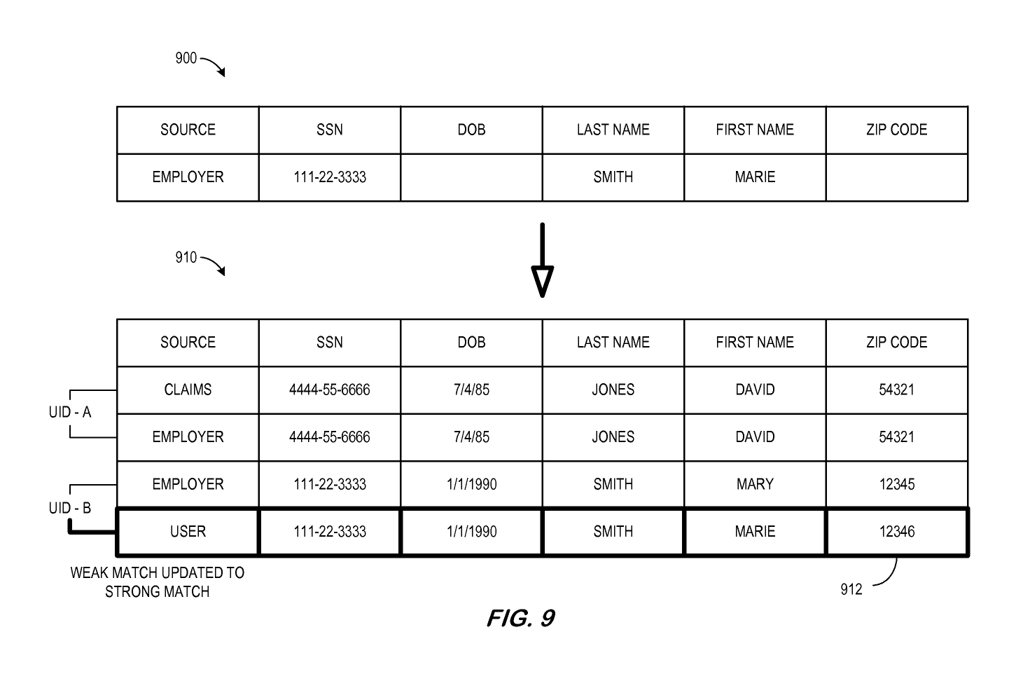

FIG. 9 illustrates updating a weak match to a strong match when supplemental user information is received according to some embodiments of the present invention. In this example, an integrated database 910 might initially include four records, two associated with UID A, one strongly associated with UID B, and one record 912 weakly associated with UID B. In this example, supplemental user information 900 is received and compared to information in the integrated database 910. The supplemental user information 900 is received from an employer (the source) and includes the user's Social Security number, last name (“Smith”), and first name (“Marie”). In this example, the supplemental information 900 may be matched with the weakly linked record 912. As a result, the match between that record 912 and UID B may be upgraded from “weak” to “strong” (illustrated by solid bold line in FIG. 9), and Marie Smith may now be allowed to access and/or update her information in the integrated database 910.

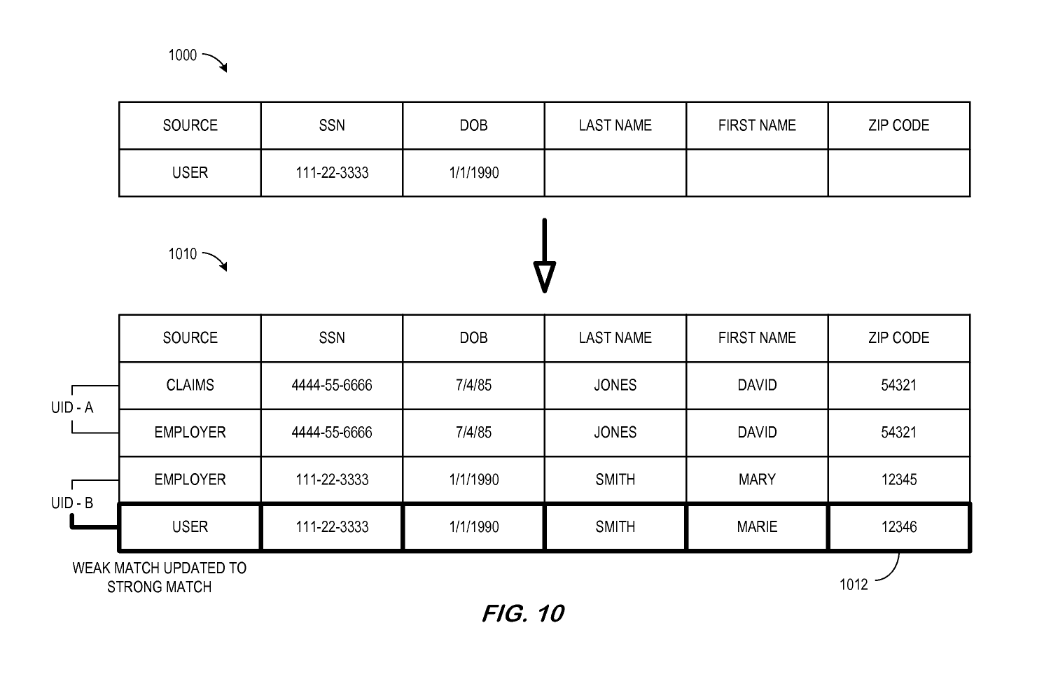

As another example, FIG. 10 illustrates updating a weak match to a strong match when supplemental user information is received from a user according to some embodiments of the present invention. As in FIG. 9, an integrated database 1010 might initially include four records, two associated with UID A, one strongly associated with UID B, and one record 1012 weakly associated with UID B. In this example, supplemental user information 1000 is received and compared to information in the integrated database 1010. The supplemental user information 1000 is received from the user (the source) and includes the user's Social Security number and date of birth. For example, the user might be prompted to provide this supplemental information 1000 via a web page or an email message. In this example, the supplemental information 1000 may be matched with the weakly linked record 1012. As a result, the match between that record 1012 and UID B may be upgraded from “weak” to “strong” (illustrated by solid bold line in FIG. 10), and Marie Smith may now be allowed to access and/or update her information in the integrated database 1010. Note that according to still other embodiments, the supplemental user information 1000 might instead be received from a third party service (e.g., a credit rating institution or department of motor vehicles).

Further note that in some cases, a weak match might be downgraded to become no match. For example, supplemental information might indicate that the new user information is actually associated with a party that did not previously exist in the integrated database at all.

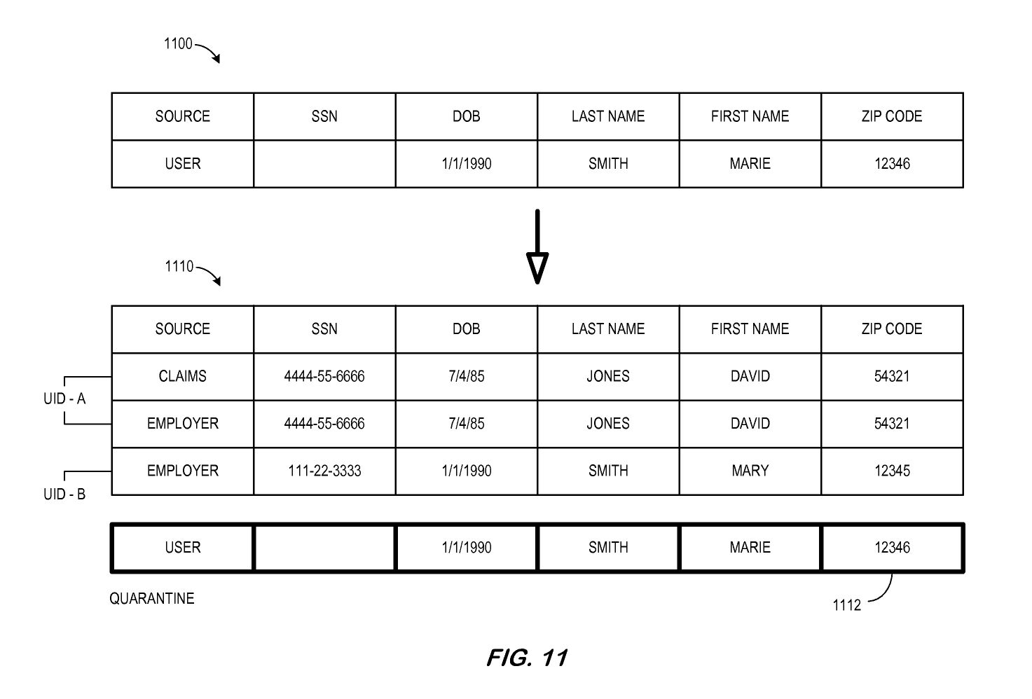

Finally, FIG. 11 illustrates how a weak match might be quarantined when new user information is received according to some embodiments of the present invention. In this example, new user information is received 1100 and compared to information in an integrated database 1110. Although some of the new user information 1100 matches data values associated with UID B, the likelihood of a match might be below a pre-determined threshold value and/or might violate one or more matching rules. As a result, a new record 1112 is created and quarantined (e.g., is held separate from the information in the integrated database 1110). In this case, the discrepancies may be investigated and eventually resolved.

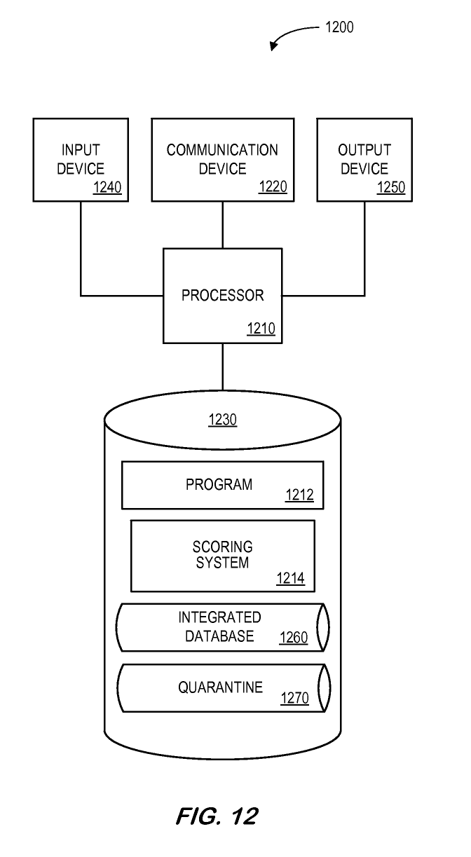

The processes described herein may be performed by any suitable device or apparatus. FIG. 12 is one example of an integrated database access platform 1200 according to some embodiments. The integrated database access platform 1200 may be, for example, associated with the system 100 of FIG. 1 and/or the system 300 of FIG. 3. The integrated database access platform 1200 comprises a processor 1210, such as one or more commercially available Central Processing Units (CPUs) in the form of one-chip microprocessors, coupled to a communication device 1220 configured to communicate via a communication network (not shown in FIG. 12). The communication device 1220 may be used to communicate, for example, with one or more remote user devices, input methods, and/or third party services. The integrated database access platform 1200 further includes an input device 1240 (e.g., a mouse and/or keyboard to enter matching rules or conditions) and an output device 1250 (e.g., a computer monitor to display aggregated reports, quarantined records, and/or results to an administrator).

The processor 1210 also communicates with a storage device 1230. The storage device 1230 may comprise any appropriate information storage device, including combinations of magnetic storage devices (e.g., a hard disk drive), optical storage devices, and/or semiconductor memory devices. The storage device 1230 stores a program 1212 and/or scoring system 1214 for controlling the processor 1210. The processor 1210 performs instructions of the programs 1212, 1214, and thereby operates in accordance with any of the embodiments described herein. For example, the processor 1210 may receive new user information and determined that the new user information does not qualify as a strong match with any record in an integrated database 1260. Moreover, the processor 1210 may determine, based on a probabilistic pattern match of the new user information with values in the fields of the integrated database 1260, that the new user information qualifies as a weak match with a particular record in the integrated database 1260. Subsequent to the determination of a weak match, supplemental user information may be received, and, responsive to the supplemental user information, the match between the new user information and the particular record in the integrated database may be upgraded by the processor 1210 from a weak match to a strong match

Referring again to FIG. 12, the programs 1212, 1214 may be stored in a compressed, uncompiled and/or encrypted format. The programs 1212, 1214 may furthermore include other program elements, such as an operating system, a database management system, and/or device drivers used by the processor 1210 to interface with peripheral devices.

As used herein, information may be “received” by or “transmitted” to, for example: (i) the integrated database access platform 1200 from another device; or (ii) a software application or module within the integrated database access platform 1200 from another software application, module, or any other source.

In some embodiments (such as shown in FIG. 12), the storage device 1230 stores the integrated database 1260 and a “quarantine” database 1270 (e.g., to store weak matches until they are resolved). Note that the databases illustrated herein are only examples, and additional and/or different information may be stored therein. Moreover, various databases might be split or combined in accordance with any of the embodiments described herein.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the databases described herein may be combined or stored in external systems).

Applicants have discovered that embodiments described herein may be particularly useful in connection with certain insurance products. Note, however, that other types of products may also benefit from the invention. For example, embodiments of the present invention may be used in conjunction with financial, medical, and/or other types of database records.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system for matching employees with group benefits based insurance database records, comprising:
a communication device to receive new employee information;
an integrated database including a plurality of group benefits based insurance records, each group benefits based insurance record being associated with a unique employee and having a plurality of fields;
a processor coupled to the communication device and integrated group benefits based insurance database; and
a storage device in communication with said processor and storing instructions adapted to be executed by said processor to:
determine that the new employee information does not qualify as a strong match with any group benefits based insurance record in the integrated database,
determine, based on a probabilistic pattern match of the new employee information with values in the fields of the integrated database, that the new employee information qualifies as a weak match with a particular group benefits based insurance record in the integrated database,
subsequent to said determination of a weak match, receive supplemental employee information, and
responsive to said supplemental employee information, upgrade the match between the new employee information and the particular group benefits based insurance record in the integrated database from a weak match to a strong match.

2. The system of claim 1, wherein the probabilistic pattern matching is associated with a closeness rule and a confidence level compared to a predetermined threshold.

3. The system of claim 1, wherein the probabilistic pattern matching assigns a matching score to each field in the integrated database.

4. The system of claim 1, wherein the new employee information includes at least one of: (i) name information, (ii) a Social Security number, (iii) gender information, (iv) a date of birth, (v) a ZIP code, (vi) an employee identifier, (vii) an employer identifier, (viii) an integrated database identifier, (ix) an address, or (x) a telephone number.

5. The system of claim 1, wherein the integrated database is associated with at least one of: (i) insurance policies, (ii) insurance claims, (iii) leave management, or (iv) insurance claim benefits.

6. A method of matching users with records in an integrated database, wherein the integrated database includes a plurality of records, each record being associated with a unique user and having a plurality of fields, said method comprising:
receiving new user information;
determining that the new user information does not qualify as a strong match with any record in the integrated database;
determining, based on a probabilistic pattern match of the new user information with values in the fields of the integrated database, that the new user information qualifies as a weak match with a particular record in the integrated database;
subsequent to said determination of a weak match, receiving supplemental user information; and
responsive to said supplemental user information, upgrading the match between the new user information and the particular record in the integrated database from a weak match to a strong match.

7. The method of claim 6, further comprising:
determining, based on a second probabilistic pattern match of second new user information with values in the fields of the integrated database, that the second new user information qualifies as a weak match with a second particular record in the integrated database;
receiving second supplemental user information; and
responsive to said second supplemental user information, downgrading the match between the second new user information and the second particular record in the integrated database from a weak match to no match.

8. The method of claim 7, further comprising:
integrating user data input via a plurality of independent methods into the integrated database, wherein said integrating is associated with a data cleansing process.

9. The method of claim 6, wherein the integrated database is associated with at least one of: (i) employees, (ii) insurance policies, (iii) insurance claims, or (iv) leave management.

10. The method of claim 6, wherein the new user information is received from a remote user device via a communication network.

11. The method of claim 10, wherein the supplemental user information is received from the remote user device via the communication network.

12. The method of claim 10, wherein the supplemental user information is received from a third-party service.

13. The method of claim 6, wherein the new user information includes at least one of: (i) name information, (ii) a Social Security number, (iii) gender information, (iv) a date of birth, (v) a ZIP code, (vi) an employee identifier, (vii) an employer identifier, (viii) an integrated database identifier, (ix) an address, (x) a telephone number, or (xi) a user name and password.

14. The method of claim 6, wherein the probabilistic pattern matching is associated with a closeness rule and a confidence level compared to a predetermined threshold.

15. The method of claim 14, wherein the closeness rule is associated with a Levenshtein distance.

16. The method of claim 6, wherein the probabilistic pattern matching assigns a matching score to each field in the integrated database.

17. The method of claim 6, further comprising:
prior to upgrading the match between the new user information and the particular record to a strong match, placing the new user information in quarantine.

18. A non-transitory computer-readable medium storing instructions adapted to be executed by a computer processor to perform a method associated with matching users with records in an integrated database, wherein the integrated database includes a plurality of records, each record being associated with a unique user and having a plurality of fields, said method comprising:
receiving new user information;
determining, based on a probabilistic pattern match of the new user information with values in the fields of the integrated database, that the new user information qualifies as a weak match with a particular record in the integrated database;
subsequent to said determination of a weak match, receiving supplemental user information; and
responsive to said supplemental user information, upgrading the match between the new user information and the particular record in the integrated database from a weak match to a strong match.

19. The medium of claim 18, wherein the probabilistic pattern matching is associated with a closeness rule and a confidence level compared to a predetermined threshold.

20. The medium of claim 18, wherein the weak match is determined based on an employee identifier and the supplemental user information comprises at least a portion of a Social Security number.
